(19) United States
(12) Patent Application Publication
(10) Pub. No.: US 2004/0204081 A1
(43) Pub. Date: Oct. 14, 2004

(54) Apparatus and method for recognizing connections of digital camera and ear-microphone in mobile communication terminal

(75) Inventor: Dong-Sub Kim, Kumi-shi (KR)

Correspondence Address: PAUL J. FARRELL, ESQ., DIL WORTH & BARRESE, LLP, 333 Earle Ovington Blvd., Uniondale, NY, 11553, US

(73) Assignee: SAMSUNG ELECTRONICS CO., LTD., Kyungki-do (KR)

(21) Appl. No.: 10/335,723

(22) Filed: Jan. 2, 2003

(30) Foreign Application Priority Data
Mar. 12, 2002 (KR) 2002-13241

(51) Int. Cl. H04M 1/00; H04B 1/38

(52) U.S. Cl. 455/557; 455/569.1

(57) ABSTRACT

An apparatus and method for identifying and recognizing a connection of a portable digital camera or an ear-microphone when the portable digital camera or the ear-microphone is connected to a mobile communication terminal through its single external input terminal are disclosed. When any jack is inserted into a jack connector of the mobile communication terminal, a jack sensor outputs a sensing signal to a controller. When the controller receives the sensing signal, it controls a switching unit having switches. If there is data to be inputted from the jack connector within a predetermined time period, the controller recognizes that the digital camera has been connected to the jack connector and then changes an operating mode to a camera mode. On the other hand, if there is no data to be inputted from the jack connector for the predetermined time period, the controller recognizes that the ear-microphone has been connected to the jack connector and then changes the operating mode to an ear-microphone mode.

### PRIORITY

This application claims priority to an application entitled “APPARATUS AND METHOD FOR RECOGNIZING CONNECTIONS OF DIGITAL CAMERA AND EAR-MICROPHONE IN MOBILE COMMUNICATION TERMINAL”, filed in the Korean Industrial Property Office on Mar. 12, 2002 and assigned Serial No. 2002-13241, the contents of which are hereby incorporated by reference.

### BACKGROUND OF THE INVENTION

1. Field of the Invention

The present invention relates to an apparatus and method for identifying and recognizing a connection of an external device when the external device is connected to a mobile communication terminal, and more particularly to an apparatus and method for identifying and recognizing a connection of a portable digital camera or an ear-microphone when the portable digital camera or the ear-microphone is connected to a mobile communication terminal through its single external input terminal.

2. Description of the Related Art

Conventionally, when a portable digital camera or an ear-microphone is connected to a mobile communication terminal, a jack connector 3 provided within a mobile communication terminal 1 as shown in FIG. 1, is used. FIG. 1 shows the mobile communication terminal, the digital camera and the ear-microphone. The portable digital camera 5 renders a captured image into a bitmap, records digital luminance of the captured image as a digital quantity, stores the captured image in an internal storage device, and transmits the captured image to the mobile communication terminal 1. A camera jack 7 coupled to the portable digital camera 5 is inserted into the jack connector 3 so that the captured image can be transmitted. Further, an ear-microphone jack 11 coupled to the ear-microphone 9 may be inserted into the jack connector 3 to connect the ear-microphone 9 to the mobile communication terminal so that a user of the mobile communication terminal can carry out hands-free communication.

Accordingly, the mobile communication terminal 1 conventionally measures electrical resistance between the contact surfaces of the jack connector 3 and the jack and then identifies and recognizes an external device connected to the mobile communication terminal 1 on the basis of measured value. In other words, the mobile communication terminal 1 stores a value of an electrical resistance between the camera jack 7 and a contact surface of the jack connector 3, and stores a value of an electrical resistance between the ear-microphone jack 11 and a contact surface of the jack connector 3. Thereafter, when the mobile communication terminal 1 senses jack insertion, the mobile terminal measures the electrical resistance between the jack and the contact surface of the jack connector 3. The mobile communication terminal 1 will identify and recognize, using the value of electrical resistance, whether the digital camera 5 or the ear-microphone 9 is collected to the mobile communication terminal 1. The mobile communication terminal 1 performs a corresponding operation based on the identification and recognition.

Therefore, if any camera jack or any ear-microphone jack not having a predetermined value of electrical resistance is inserted, there is a problem in that the mobile communication terminal 1 cannot recognize what external device is inserted into the jack connector.

### SUMMARY OF THE INVENTION

Therefore, the present invention has been made in view of the above problems, and it is an object of the present invention to provide a connection recognition apparatus and method for identifying and recognizing whether a digital camera or an ear-microphone is connected to a same jack connector.

It is another object of the present invention to provide an apparatus and method for recognizing connections of various types of digital cameras and ear-microphones, regardless of the value of electrical resistance at the jack connector.

In accordance with one aspect of the present invention, the above and other objects can be accomplished by the provision of a mobile communication terminal connected to a digital camera or an ear-microphone through a same jack connector, comprising: a jack sensor for sensing whether any jack is inserted into the jack connector and outputting a sensing signal; a hands-free unit for outputting data to be inputted into the jack connector to a switching unit and outputting data to be inputted from the switching unit to the jack connector; the switching unit for switching data to be inputted from the hands-free unit in a standby state to a controller, switching data to be inputted from the controller to the hands-free unit, switching data to be inputted from the jack connector to the controller in response to an input of a switching signal, and switching data to be inputted from the controller to the jack connector; and the controller for outputting the switching signal if there is an input of the sensing signal, recognizing that the digital camera has been connected to the mobile communication terminal if there is data to be inputted from the switching unit within the predetermined time period and then changing an operating mode into a camera mode, and recognizing that the ear-microphone has been connected to the mobile communication terminal if there is no data to be inputted from the switching unit within the predetermined time period, stopping an output of the switching signal, and changing the operating mode to an ear-microphone mode.

In accordance with another aspect of the present invention, there is provided a method for recognizing connections of a digital camera and an ear-microphone in a mobile communication terminal in which the digital camera or the ear-microphone is connected through a same jack connector, the mobile communication terminal including a jack sensor for sensing whether any jack is inserted into the jack connector and outputting a sensing signal; a hands-free unit for outputting data to be inputted into the jack connector to a switching unit and outputting data to be inputted from the switching unit to the jack connector; and the switching unit for switching data to be inputted from the hands-free unit in a standby state to a controller, switching data to be inputted from the controller to the hands-free unit, switching data to be inputted from the jack connector to the controller in response to an input of a switching signal, and switching data to be inputted from the controller to the jack connector, the method comprising the steps of: a) determining whether there is an input of the sensing signal; b) outputting the switching signal if there is an input of the sensing signal; c) recognizing that the digital camera has been connected to the mobile communication terminal if there is data to be inputted from the switching unit within the predetermined time period and then changing an operating mode into a camera mode; and d) recognizing that the ear-microphone has been connected to the mobile communication terminal if there is no data to be inputted from the switching unit within the predetermined time period, stopping an output of the switching signal, and changing the operating mode to an ear-microphone mode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a mobile communication terminal, a digital camera and an ear-microphone;

FIG. 2 is a block diagram showing a configuration of a mobile communication terminal of the present invention;

FIG. 3 is a block diagram showing configurations of a jack connector and a switching unit in accordance with an embodiment of the present invention; and

FIG. 4 is a flow chart showing a control process of a controller in accordance with an embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, well known details and functions are omitted to avoid making the subject matter of the present invention unclear.

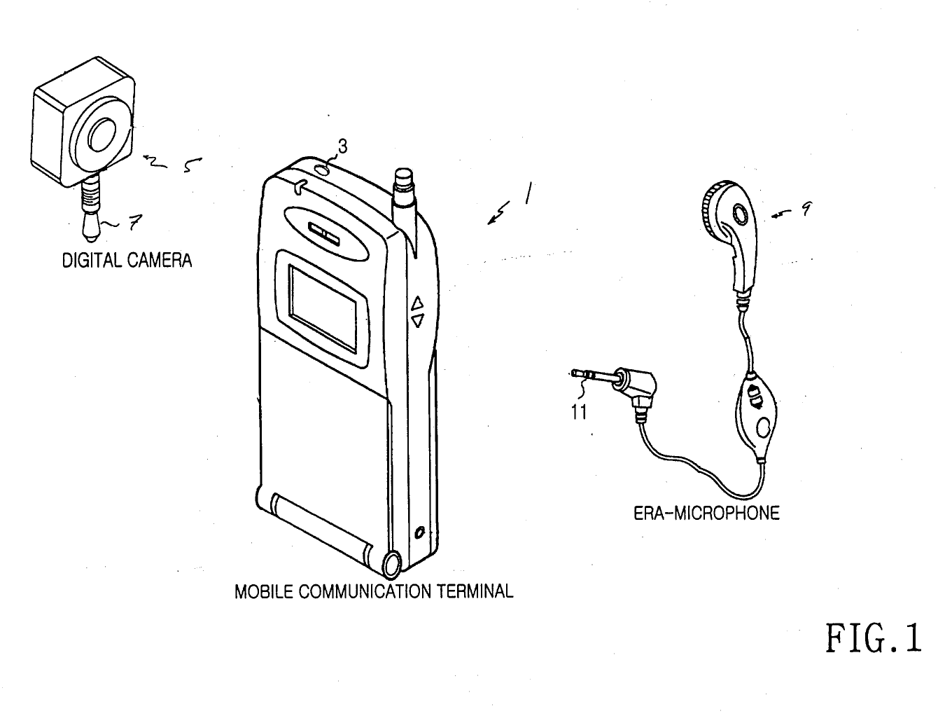

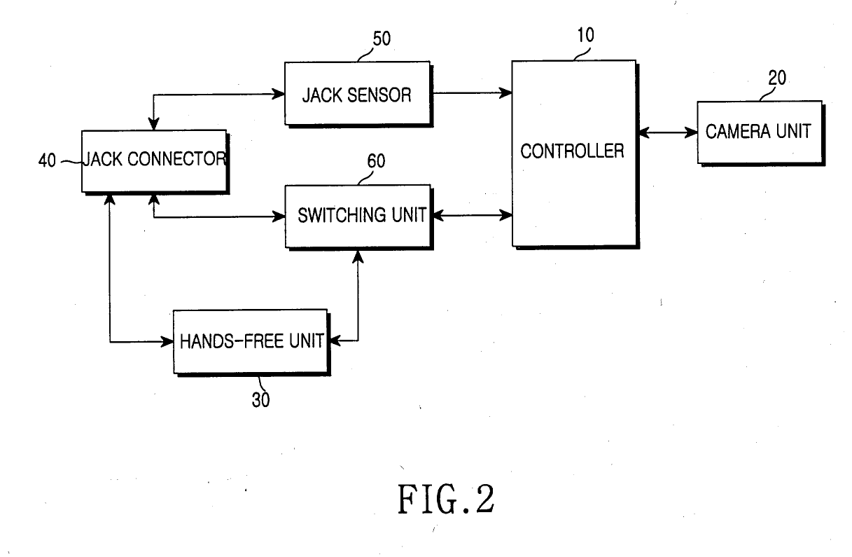

First, a configuration of a mobile communication terminal applied in the present invention will be described with reference to the block diagram of FIG. 2. As shown in FIG. 2, the mobile communication terminal includes a controller 10, a camera unit 20, a hands-free or ear-microphone interface unit 30, a jack connector 40, a jack sensor 50 and a switching unit 60. The controller 10 performs an overall control function of the mobile communication terminal. The jack connector 40 is a connection terminal for connecting a digital camera 5 or an ear-microphone 9. A camera jack 7 or an ear-microphone jack 11 is inserted into the jack connector 40 (shown as connector 3 in FIG. 1). The jack sensor 50 connected to the jack connector 40 senses whether a jack is inserted into the jack connector 40, thereby outputting a sensing signal to the controller 10. The camera unit 20 processes video data received from the digital camera 5 under control of the controller 10. The hands-free unit 30 outputs data inputted from the jack connector 40 to the controller 10 via the switching unit 60. The hands-free unit 30 receives data inputted from the controller 10 through the switching unit 60 in order to output it to the jack connector 40. The switching unit 60 is composed of a plurality of switches. The switching unit 60 switches video data inputted from the digital camera 5 connected to the jack connector 40 to the controller 10 according to its switching control. The switching unit 60 switches voice data to be inputted from the hands-free unit 30 to the controller 10 according to its switching control. Further, the switching unit 60 switches voice data to be inputted from the controller 10 to the hands-free unit 30.

When any jack is inserted into the jack connector 40 in the mobile communication terminal described above, the jack sensor 50 outputs the sensing signal to the controller 10. When the controller 10 receives the sensing signal, it controls the switches included in the switching unit 60 so that the data to be inputted from the jack connector 40 can be outputted to the controller 10. Subsequently, the controller 10 can monitor whether there is data to be inputted through the jack connector 40 for a predetermined time period. If there is data to be inputted for the predetermined time period, the controller 10 recognizes that the digital camera 5 has been connected to the jack connector 40 and then drives the camera unit 20. Otherwise, the controller 10 recognizes that the ear-microphone 9 is connected to the jack connector 40 and then controls the switching operation of the switching unit 60 so that the data can be inputted through the hands-free unit 30 to the controller 10.

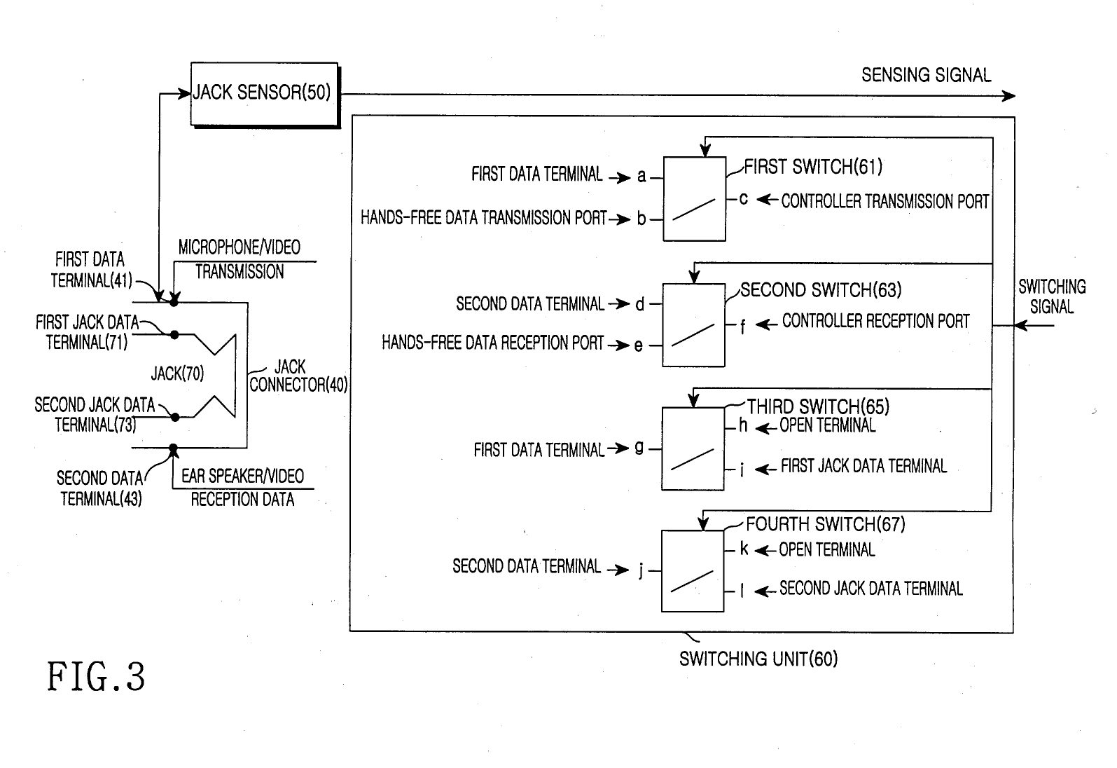

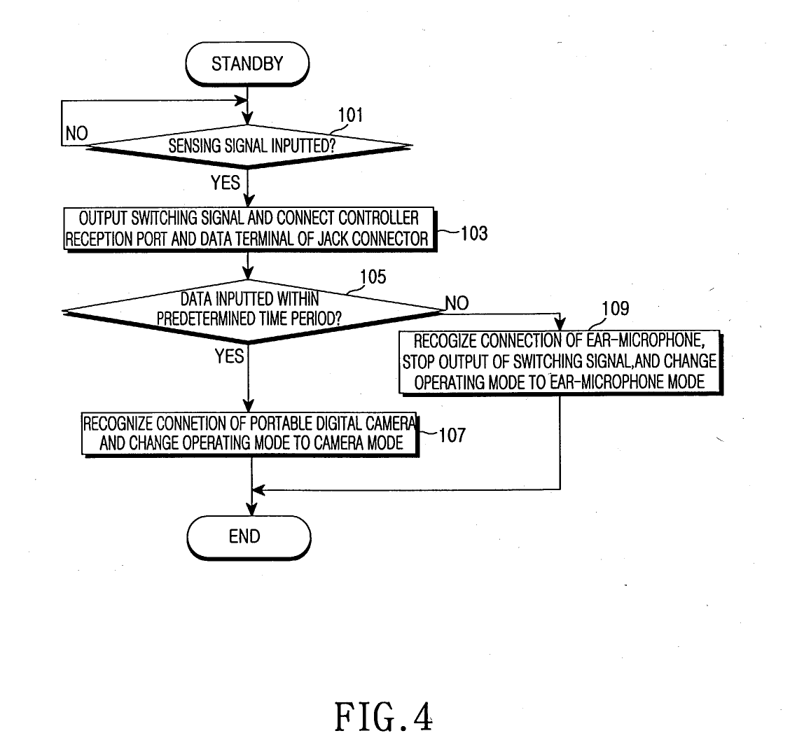

In accordance with the embodiment of the present invention, the detailed configuration of the switching unit 60 operating according to control of the controller 10 and a control process of the controller 10 will be described with reference to FIGS. 3 and 4. FIG. 3 is a block diagram showing configurations of the jack connector 40 and the switching unit 60. As shown in FIG. 3, the jack connector 40 includes a first data terminal 41 and a second data terminal 43 through which data is inputted and outputted. A jack 70 includes a first jack data terminal 71 and a second jack data terminal 73 through which data is inputted and outputted regardless of the type of external device. The first data terminal 41 is connected to the first jack data terminal 71 when the jack 70 is inserted into the jack connector 40, and the second data terminal 43 is connected to the second jack data terminal 73 when the jack 70 is inserted into the jack connector 40.

Therefore, the first data terminal 41 can connect to a microphone of the ear-microphone 9 to receive the voice data to be inputted through the microphone, or, if the digital camera 5 is connected, can output video transmission data to be transmitted to the digital camera 5.

The second data terminal 43 is connected to an ear speaker of the ear-microphone 9 to output the voice data to be provided from the mobile communication terminal, or to receive the video reception data from the digital camera 5.

The switching unit 60 includes a first switch 61 and a second switch 63, a third switch 65 and a fourth switch 67. The respective switches are switched in response to switching signals. The first switch 61 includes an “a” terminal connected to the first data terminal 41, a “b” terminal connected to a hands-free data transmission port, and a “c” terminal connected to a controller transmission port. The second switch 63 includes a “d” terminal connected to the second data terminal 43, an “e” terminal connected to a hands-free data reception port, and an “f” terminal connected to a controller reception port. The third switch 65 includes a “g” terminal connected to the first data terminal 41, an “h” terminal being an open port, and an “i” terminal connected to the first jack data terminal 71. The fourth switch 67 includes a “j” terminal connected to the second data terminal 43, a “k” terminal being an open terminal, and an “l” terminal connected to the second jack data terminal 73.

The switching operation according to the control of the controller 10 controlling the switches described above will now be described.

In a standby state, the first switch 61 connects the “b” and “c” terminals together, so that the controller transmission port and hands-free data transmission port are connected to each other. The second switch 63 connects the “e” and “f” terminals together, so that the controller reception port and the hands-free data reception port are connected to each other. The third switch 65 and the fourth switch 67 connect the “h” and “k” terminals, respectively, and therefore become open.

Thereafter, if the jack 70 of any external device is inserted into the jack connector 40, the jack sensor 50 senses the insertion of the jack 70 and outputs the sensing signal to the controller 10. If the controller 10 receives the sensing signal, it applies a switching signal to the switching unit 60 to control the switches. In response to the switching signal, the first switch 61 is switched and then connects the “a” and “c” terminals so that the controller transmission port and the first data terminal 41 are connected to each other. In response to a switching signal, the second switch 63 is switched and then connects the “d” and “f” terminals so that the controller reception port and the second data terminal 43 are connected to each other. The third switch 65 is switched and then connects the “g” and “i” terminals so that the first data terminal 41 and the first jack data terminal 71 are connected to each other. The fourth switch 67 is switched and then connects the “j” and “l” terminals so that the second data terminal 43 and the second jack data terminal 73 are connected to each other.

Thereafter, the controller 10 monitors whether there is data to be inputted into the controller reception port for the predetermined time period. In other words, the controller 10 monitors whether there is data to be inputted from the second data terminal 43. If the jack 70 connected to the jack connector 40 is the jack of the ear-microphone 9, no data is inputted into the second data terminal 43. However, where the jack 70 inserted into the jack connector 40 is the jack of the portable digital camera 5, the video reception data from the digital camera 5 is inputted into the second data terminal 43. Therefore, if data is inputted from the second data terminal to the controller 10 during the predetermined time period, the portable digital camera 5 has been connected to the mobile communication terminal. Thereafter, if the controller 10 senses the input of the data within the predetermined time period, it recognizes that the digital camera 5 has been connected to the mobile communication terminal and then drives the camera unit 20 to change an operating mode to a camera mode. Otherwise, the controller 10 recognizes that the ear-microphone 9 has been connected to the mobile communication terminal and then stops the output of the switching signal so that the respective switches in standby states are changed to an ear-microphone mode.

FIG. 4 is a flow chart illustrating a control operation of the controller 10. As shown in FIG. 4, the controller 10 determines at step 101 whether a sensing signal has been inputted from the jack sensor 50. If the sensing signal has been inputted from the jack sensor 50, the controller 10 proceeds to step 103. The controller 10 outputs a switching signal to the switching unit 60 so that the controller reception port and a data terminal of the jack connector 40 are connected. Thereafter, the controller 10 confirms at step 105 whether there is data to be inputted into the controller reception port. If the there is data to be inputted into the controller reception port, the controller 10 proceeds to step 107. The controller 10 recognizes that the portable digital camera 5 has been connected to the jack connector 40 and then drives the camera unit 20 to change an operating mode to the camera mode at step 107. On the other hand, if the there is no data to be inputted into the controller reception port, the controller 10 recognizes that the ear-microphone 9 has been connected to the jack connector 40 and then controls the switching unit 60 to change the operating mode to the ear-microphone mode at step 109.

As apparent from the above description, the present invention provides an apparatus and method capable of sensing whether the jack 70 has been inserted into the jack connector 40 and then identifying and recognizing a connection of an external device on the basis of a data input within a predetermined time period.

Although the preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments, but the present invention is defined by the claims which follow, along with their full scope of equivalents.

What is claimed is:

1. A mobile communication terminal connectable to a digital camera or an ear-microphone through a same jack connector, comprising:
a jack sensor for sensing whether a jack is inserted into the jack connector and outputting a sensing signal;
a hands-free unit for outputting data to a switching unit inputted into the jack connector, and for outputting data to the jack connector inputted from the switching unit;
the switching unit for switching data inputted from the hands-free unit in a standby state to a controller, switching data to be inputted from the controller to the hands-free unit, switching data to be inputted from the jack connector to the controller in response to an input of a switching signal, and switching data to be inputted from the controller to the jack connector; and
the controller for outputting the switching signal if there is an input of the sensing signal, recognizing that the digital camera has been connected to the jack connector if data is input from the switching unit within a predetermined time period and then changing an operating mode to a camera mode, and recognizing that the ear-microphone has been connected to the jack connector if no data to is input from the switching unit within the predetermined time period, stopping an output of the switching signal, and changing the operating mode to an ear-microphone mode.

2. A method for recognizing connections of a digital camera and an ear-microphone to a mobile communication terminal in which the digital camera or the ear-microphone is connected through a same jack connector, the mobile communication terminal including a jack sensor for sensing whether a jack is inserted into the jack connector and outputting a sensing signal; a hands-free unit for outputting data to a switching unit inputted into the jack connector, and for outputting data to the jack connector inputted from the switching unlit; and the switching unit for switching data inputted from the hands-free unit in a standby state to a controller, switching data to be inputted from the controller to the hands-free unit, switching data to be inputted from the jack connector to the controller in response to an input of a switching signal, and switching data to be inputted from the controller to the jack connector, the method comprising the steps of:
a) determining whether there is an input of the sensing signal;
b) outputting the switching signal if there is an input of the sensing signal;
c) recognizing that the digital camera has been connected to the mobile communication terminal if there is data to be inputted from the switching unit within a predetermined time period and then changing an operating mode into a camera mode; and
d) recognizing that the ear-microphone has been connected to the jack connector if no data is input from the switching unit within the predetermined time period, stopping an output of the switching signal, and changing the operating mode to an ear-microphone mode.
